(19) United States
(12) Patent Application Publication
(10) Pub. No.: US 2025/0221326 A1
(43) Pub. Date: Jul. 10, 2025

(54) Method for Variable Application of Residual Herbicides Using Imaging and/or Historical Weed Data

(71) Applicant: Centure Applications LTD, Tel Aviv (IL)

(72) Inventor: Itzhak Khait, Vaughan (CA)

(21) Appl. No.: 19/016,199

(22) Filed: Jan. 10, 2025

Related U.S. Application Data
(60) Provisional application No. 63/619,429, filed on Jan. 10, 2024.
(60) Provisional application No. 63/558,886, filed on Feb. 28, 2024.

(51) Int. Cl. A01B 39/18; A01M 21/04; G06V 10/762; G06V 20/10; G06V 20/56

(52) U.S. Cl. CPC A01B 39/18; A01M 21/043; G06V 10/762; G06V 20/188; G06V 20/56; G06V 2201/07

(57) ABSTRACT

A method for spraying an agricultural field using a spray system that includes a spray boom attached to an agricultural vehicle and including cameras and broadcast nozzles, the agricultural vehicle having a tank that stores a residual herbicide. The method includes capturing images of regions of the agricultural field, each camera associated with one or more broadcast nozzles; automatically analyzing, with a trained machine learning (ML) model, each image for target weed(s); automatically detecting the target weed(s) in one or more images; for each image in which the target weed(s) is detected, automatically spraying first region(s) with one or more first broadcast nozzles at an increased application rate compared to a default application rate; and for at least some of the images in which the at least one weed is not detected, automatically spraying second region(s) with the one or more second broadcast nozzles at the default application rate.

### CROSS-REFERENCE TO RELATED APPLICATIONS

This application claims priority to U.S. Provisional Application No. 63/619,429, tiled “Selective Application of Residual and Non-Residual Herbicides to Weeds With Variable Spray Areas and Spray Configurations,” filed Jan. 10, 2024 and to U.S. Provisional Application No. 63/558,886, titled “System and Method to Improve Precision Application From Dual-Line Spray Boom,” filed Feb. 28, 2024, which are hereby incorporated by reference.

### TECHNICAL FIELD

This application relates generally to agricultural spray systems.

### BACKGROUND

Agricultural spray systems include spray booms with nozzles to spray an agricultural field. The nozzles include broadcast nozzles that apply a general-application agricultural product to the agricultural field at a uniform rate.

### SUMMARY

Example embodiments described herein have innovative features, no single one of which is indispensable or solely responsible for their desirable attributes. The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Without limiting the scope of the claims, some of the advantageous features will now be summarized. Other objects, advantages, and novel features of the disclosure will be set forth in the following detailed description of the disclosure when considered in conjunction with the drawings, which are intended to illustrate, not limit, the invention.

An aspect of the invention is directed to a method for spraying an agricultural field, comprising: in a spray system that includes a spray boom attached to an agricultural vehicle, the spray boom including one or more cameras and a plurality of broadcast nozzles, the agricultural vehicle having an application tank that stores at least a residual herbicide: capturing, with each camera, images of respective regions of an agricultural field, each region at a predetermined distance from the spray boom, each camera associated with one or more respective broadcast nozzles; automatically analyzing, with a trained machine learning (ML) model running on a computer, each image for a presence of at least one target weed, the trained ML model having been trained with first images that include the at least one target weed and second images that do not include the at least one target weed; automatically detecting, with the trained ML model, the at least one target weed in one or more of the images; for each image in which the at least one target weed is detected, automatically spraying a respective first region with one or more respective first broadcast nozzles at an increased application rate compared to a default application rate; and for at least some of the images in which the at least one target weed is not detected, automatically spraying a respective second region with the one or more respective second broadcast nozzles at the default application rate.

In one or more embodiments, automatically spraying the respective first region at the increased application rate comprises opening and closing a respective valve of each first broadcast nozzle at a frequency and an increased duty cycle compared to a default duty cycle, and automatically spraying the respective second region at the default application rate comprises opening and closing the respective valve of each second broadcast nozzle at the frequency and the default duty cycle. In one or more embodiments, the method further comprises automatically spraying at least one neighboring region of at least one respective first region at the increased application rate.

In one or more embodiments, the method further comprises automatically detecting, with the computer, a cluster of weeds in a group of regions of the agricultural field; and automatically spraying the group of regions at the increased application rate. In one or more embodiments, the method further comprises automatically spraying at least one neighboring region of the group of regions at the increased application rate.

Another aspect of the invention is directed to a method for spraying an agricultural field, comprising: in a spray system that includes a spray boom attached to an agricultural vehicle, the spray boom including a plurality of broadcast nozzles, the agricultural vehicle having an application tank that stores at least a residual herbicide: comparing, in a computer, historical weed data for regions of the agricultural field to a predetermined threshold; for first regions in which the historical weed data are higher than the predetermined threshold, automatically spraying a respective first region with one or more respective first broadcast nozzles at an increased application rate compared to a default application rate; and for at least some second regions in which the historical weed data are lower than or equal to the predetermined threshold, automatically spraying a respective second region with the one or more respective second broadcast nozzles at the default application rate.

In one or more embodiments, automatically spraying the respective first region at the increased application rate comprises opening and closing a respective valve of each first broadcast nozzle at a frequency and an increased duty cycle compared to a default duty cycle, and automatically spraying the respective second region at the default application rate comprises opening and closing the respective valve of each second broadcast nozzle at the frequency and the default duty cycle. In one or more embodiments, the method further comprises automatically spraying at least one neighboring region of at least one respective first region at the increased application rate.

Another aspect of the invention is directed to a method for spraying an agricultural field, comprising: in a spray system that includes a spray boom attached to an agricultural vehicle, the spray boom including one or more cameras and a plurality of broadcast nozzles, the agricultural vehicle having an application tank that stores at least a residual herbicide: comparing, in a computer, historical weed data of regions of the agricultural field to a predetermined threshold; capturing, with each camera, a respective image of respective regions of an agricultural field, each region at a predetermined distance from the spray boom, each camera associated with one or more respective broadcast nozzles; automatically analyzing, with a trained ML model running on the computer, each image for a presence of at least one target weed, the trained ML model having been trained with first images that include the at least one target weed and second images that do not include the at least one target weed; automatically detecting, with the trained ML model, the at least one target weed in one or more of the images; determining, with the trained ML model, a plurality of first regions of the agricultural field to spray at an increased application rate compared to a default application rate, the first regions determined using the historical weed data and/or a detection of the at least one weed in the one or more images; automatically spraying each first region with one or more respective first broadcast nozzles at the increased application rate; and automatically spraying one or more second regions of the agricultural field with one or more respective second broadcast nozzles at the default application rate.

In one or more embodiments, automatically spraying each first region at the increased application rate comprises opening and closing a respective valve of each first broadcast nozzle at a frequency and an increased duty cycle compared to a default duty cycle, and automatically spraying the one or more second regions at the default application rate comprises opening and closing the respective valve of each second broadcast nozzle at the frequency and the default duty cycle.

In one or more embodiments, the method further comprises automatically spraying at least one neighboring region of at least one first region at the increased application rate. In one or more embodiments, the method further comprises automatically detecting a cluster of weeds in a group of regions of the agricultural field; and automatically spraying the group of regions at the increased application rate. In one or more embodiments, the method further comprises automatically spraying at least one neighboring region of the group of regions at the increased application rate.

Another aspect of the invention is directed to a method for spraying an agricultural field, comprising: in a spray system that includes a spray boom attached to an agricultural vehicle, the spray boom including one or more cameras and a plurality of spray nozzles, the agricultural vehicle having an application tank that holds an herbicide mixture that includes at least one residual herbicide and at least one non-residual herbicide, the application tank fluidly coupled to the spray nozzles: defining, with a computer, a spray configuration for the spray nozzles; automatically capturing, with each camera, a respective image of a respective region of an agricultural field, each region at a predetermined distance from the spray boom, each camera associated with one or more respective spray nozzles; automatically analyzing, with a trained machine learning (ML) model running on the computer, each image for a presence of at least one target weed, the trained ML model having been trained with first images that include the at least one target weed and second images that do not include the at least one target weed; automatically detecting, with the trained ML model, the at least one target weed in one or more of the images; and automatically spraying respective regions of the agricultural field with the spray nozzles in the spray configuration and based, at least in part, on a detection of the at least one weed in the one or more images.

In one or more embodiments, the spray nozzles include broadcast nozzles, and the method further comprises: for each image in which the at least one weed is detected, automatically spraying a respective first region with one or more respective first broadcast nozzles at an increased application rate compared to a default application rate; and for at least some of the images in which the at least one weed is not detected, automatically spraying a respective second region with the one or more respective second broadcast nozzles at the default application rate.

In one or more embodiments, the spray nozzles include broadcast nozzles and selective spot-spray (SSP) nozzles, the broadcast nozzles configured to align with respective rows of crops, the SSP nozzles configured to align with spaces between neighboring rows of crops, and the method further comprises: for each image in which the at least one weed is detected, automatically spraying a respective first region with one or more respective SSP nozzles; and broadcast spraying the rows of crops with the broadcast nozzles.

In one or more embodiments, the spray nozzles include broadcast nozzles and selective spot-spray (SSP) nozzles, the SSP nozzles configured to align with respective rows of crops, the broadcast nozzles configured to align with spaces between neighboring rows of crops, and the method further comprises: for each image in which the at least one weed is detected, automatically spraying a respective first region with one or more respective SSP nozzles; and broadcast spraying the spaces between neighboring rows of crops with the broadcast nozzles.

### BRIEF DESCRIPTION OF THE DRAWINGS

For a fuller understanding of the nature and advantages of the concepts disclosed herein, reference is made to the detailed description of preferred embodiments and the accompanying drawings.

FIG. 1 is an isometric view of a dual-sprayer system according to one or more embodiments.

FIG. 2 is a side view of a dual-sprayer system according to one or more embodiments.

FIG. 3 is a block diagram of a spray system for selectively applying a treatment to a target region according to one or more embodiments.

FIG. 4 is a simplified block diagram of fluid and electrical circuits for a sprayer system according to one or more embodiments.

FIG. 5 is a simplified block diagram of a spray boom to illustrate the variable application rate of the general-application liquid agricultural product(s) according to one or more embodiments.

FIG. 6 is a simplified block diagram of spray regions and neighboring spray regions according to one or more embodiments.

FIG. 7 is a simplified block diagram of a spray boom to illustrate the variable application rate of the general-application liquid agricultural product(s) according to another embodiment.

FIG. 8 illustrates examples images of an agricultural field according to one or more embodiments.

FIG. 9 illustrates examples images of an agricultural field according to another embodiment.

FIG. 10 is a flow chart of a method for broadcast spraying an agricultural field using a variable duty cycle according to one or more embodiments.

FIG. 11 is a flow chart of a method for broadcast spraying an agricultural field using a variable duty cycle according to another embodiment.

FIG. 12 is a simplified block diagram of fluid and electrical circuits for a sprayer system according to another embodiment.

FIG. 13 is a simplified block diagram of fluid and electrical circuits for a sprayer system according to another embodiment.

FIG. 14 is a flow chart for a method for applying residual and non-residual herbicides to target plants or features according to one or more embodiments.

FIG. 15 is a simplified block diagram of fluid and electrical circuits for a sprayer system according to another embodiment.

### DETAILED DESCRIPTION

An agricultural sprayer is configured to selectively increase the application rate of general-application liquid agricultural products that are sprayed through broadcast nozzles in response to (a) the detection of weeds and/or (b) historical weed data indicating a high concentration of weeds. The application rate can be selectively increased by increasing the duty cycle of one or more valves for one or more respective broadcast nozzles. Additionally or alternatively, some broadcast nozzles can be maintained in an activated state at a default or baseline application rate and one or more additional broadcast nozzles can be selectively turned on to increase the application rate. The broadcast nozzles can be controlled individually and/or in groups/sectors.

In some embodiments, some of the spray nozzles can be configured to spot spray a spray area on the agricultural field and other spray nozzles can be configured to broadcast spray. The broadcast sprays can be used to continuously spray crop rows. The spot sprays can be used to spot spray the areas between neighboring crop rows.

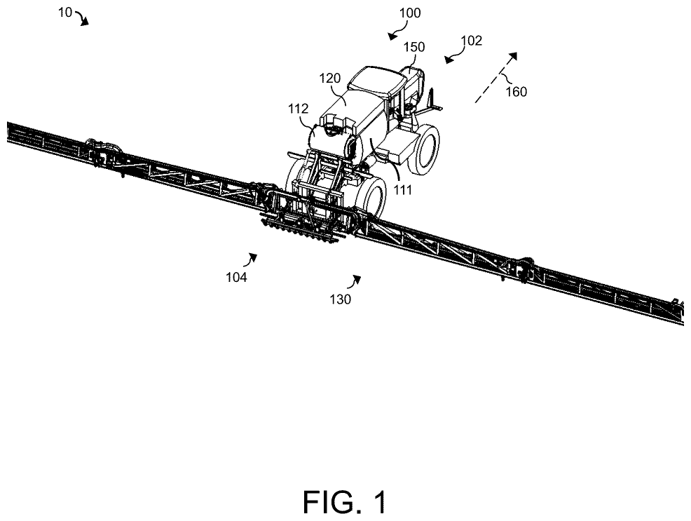

FIG. 1 is an isometric view of a dual-sprayer system 10 according to one or more embodiments. The system 10 includes an agricultural vehicle 100, a broadcast tank 111, a selective-spot spray (SSP) tank 112, a rinse tank 120, and a spray boom 130.

The broadcast tank 111 is mounted on the agricultural vehicle 100 and is configured to hold one or more general-application liquid agricultural products (e.g., one or more herbicides (e.g., residual herbicides that persist in the soil for an extended period, controlling weeds that germinate after application), one or more fungicides, one or more insecticides, one or more nematicides, one or more pesticides, and/or one or more fertilizers) to be sprayed broadly onto an agricultural field using the spray boom 130, which is attached to the agricultural vehicle 100. In some embodiments, the broadcast tank 111 can hold a combination or mixture of residual herbicides and non-residual herbicides. One or more first fluid lines fluidly couple the broadcast tank 111 to one or more broadcast nozzles on the spray boom 130. Valve(s) coupled to the broadcast nozzle(s) can be opened and closed at a frequency and at a variable duty cycle to control the application rate (typically measured in gallons per acre (GPA)) of the general-application liquid agricultural product(s)). The duty cycle can be varied according to the speed of the agricultural vehicle 100, the height of the spray boom 130, and/or in response to imaging of the agricultural field and analysis/detection of target features such as weeds by one or more trained machine learning models. The broadcast nozzle(s) and respective valves can controlled individually and/or in groups/sectors.

The SSP tank 112 is mounted on the agricultural vehicle 100 and is configured to hold one or more target-application or specific liquid agricultural products (e.g., one or more herbicides (e.g., non-residual herbicides), one or more fungicides, one or more insecticides, one or more nematicides, and/or one or more pesticides) that is/are designed to target one or more weeds growing and/or one or more pests and/or fungi in the agricultural field (in general, one or more target features in the agricultural field). Additionally or alternatively, the specific liquid agricultural product(s) can include one or more fertilizers and/or nitrogen-containing compounds. One or more second fluid lines fluidly couple the SSP tank to one or more SSP nozzles on the spray boom 130. The specific liquid agricultural product(s) in the SSP tank 112 are selectively sprayed using the SSP nozzle(s) in response to imaging of the agricultural field and analysis/detection of weeds and/or target features by one or more trained machine learning models. Valve(s) coupled to the SSP nozzle(s) can be opened and closed to selectively spray the detected weeds. When the valve(s) is/are opened, the valve(s) can be repeatedly opened and closed at a frequency and at a variable duty cycle. The duty cycle can be varied according to the speed of the agricultural vehicle 100 and/or the height of the spray boom 130 to maintain a uniform or substantially uniform (e.g., within about 5% to about 10%) application rate of the specific liquid agricultural product(s).

The rinse tank 120 is fluidly coupled to the broadcast tank 111 and to the SSP tank 112. Water and/or another liquid stored in the rinse tank 120 can be used to rinse the broadcast tank 111 and/or the SSP tank 112 after each tank 111, 112 is emptied. The rinse tank 120 can be optional in some embodiments.

The engine 150 for the agricultural vehicle 100 can be replaced with a motor when the agricultural vehicle 100 is electric or can include both an engine and a motor when the agricultural vehicle 100 is a hybrid vehicle. In any case, the agricultural vehicle 100 includes a mechanical drive system that powers the agricultural vehicle 100 and the wheels.

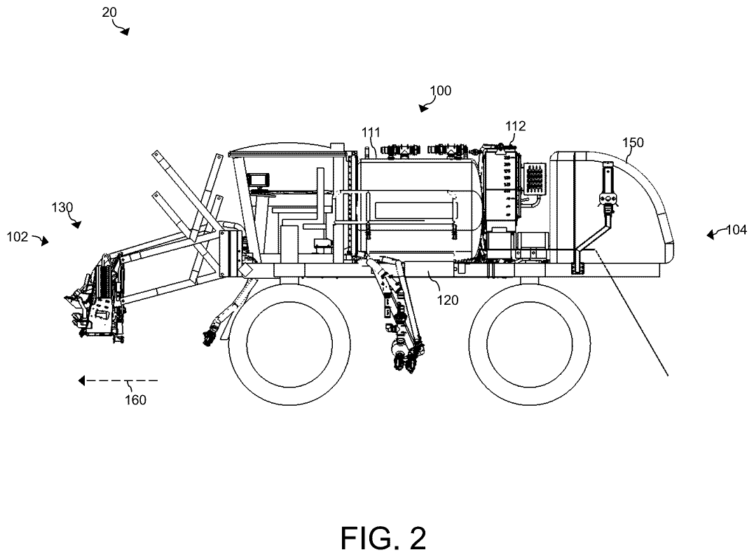

The spray boom 130 is attached to the back 104 of the agricultural vehicle 100 in a first configuration such that the agricultural vehicle 100 pulls the spray boom 130 as the agricultural vehicle 100 drives forward (e.g., in direction 160), as illustrated in FIG. 1. In a second configuration, the spray boom 130 can be attached to the front 102 of the agricultural vehicle 100 such that the agricultural vehicle 100 pushes the spray boom 130 as the agricultural vehicle 100 drives forward. An example of the second configuration is illustrated in FIG. 2, which is a side view of a dual sprayer system 20 according to another embodiment. System 20 is the same as system 10 except for the locations of the broadcast tank 111, the SSP tank 112, and the rinse tank 120 and the configuration/location of the spray boom 130.

In some embodiments, the SSP tank 112 and/or the rinse tank 120 is/are optional.

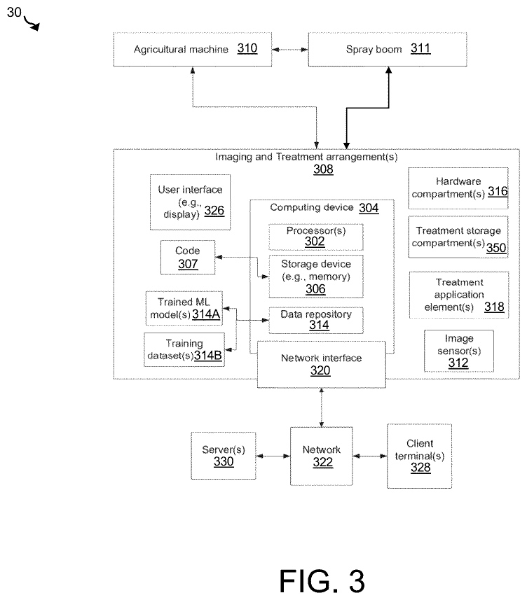

FIG. 3 is a block diagram of a spray system 30 for selectively applying a treatment to a target region according to one or more embodiments. System 30 can be the same as system 10 and/or system 20.

System 30 includes one or more imaging and treatment arrangements 308 connected to and/or mounted on an agricultural machine 310, for example, a tractor, an airplane, an off-road vehicle, or a drone. Alternatively, the imaging and treatment arrangement(s) 308 can be connected to and/or mounted on a spray boom 311, which can be the same as spray boom 130. The agricultural machine 310 can include and/or can be connected to the spray boom 311. Agricultural machine 310 can be the same as agricultural machine 100. Imaging and treatment arrangements 308 may be arranged along a length of the agricultural machine 310 and/or of the spray boom 311. For example, the imaging and treatment arrangements 308 can be evenly spaced every 1-3 meters along the length of spray boom 311. Spray boom 311 may be long, for example, 10-50 meters, or another length. Spray boom 311 may be pushed or pulled by agricultural machine 310. In another embodiment, the system 30 only includes one imaging and treatment arrangement 308.

An example imaging and treatment arrangement 308 is depicted for clarity, but it is to be understood that system 30 may include multiple imaging and treatment arrangements 308. It is noted that each imaging and treatment arrangement 308 may include all components described herein. Alternatively, one or more imaging and treatment arrangements 308 can share one or more components, for example, multiple imaging and treatment arrangements 308 can share a common computing device 304, common memory 306, and/or common processor(s) 302.

Each imaging and treatment arrangement 308 includes one or more image sensors 312 that acquire images of the agricultural field. Examples of an image sensor 312 include a color sensor, optionally a visible light-based sensor, for example, a red-green-blue (RGB) sensor such as CCD and/or CMOS sensors, and/or other cameras (e.g., cameras 640) and/or other sensors such as an infra-red (IR) sensor, a near-IR sensor, an ultraviolet sensor, a fluorescent sensor, a LIDAR sensor, an NDVI sensor, a two-dimensional sensor, a three-dimensional sensor, and/or a multispectral sensor. Image sensor(s) 312 is/are arranged and/or positioned to capture images of a portion of the agricultural field (e.g., located in front of image sensor(s) 312 and along a direction of motion of agricultural machine 310).

A computing device 304 receives the image(s) from the image sensor(s) 312, for example, via a direct connection (e.g., local bus and/or cable connection and/or short-range wireless connection), a wireless connection and/or via a network. The image(s) are processed by processor(s) 302, which feeds the image into a trained machine learning (ML) model 314A (e.g., trained on a training dataset(s) 314B that include training images of agricultural fields with one or more target features, such as target weeds, target pests/insects, target fungi and training images of agricultural fields without any target features). Training dataset(s) 314B are used to train an untrained ML model to create the trained ML model 314A and may not be included in system 30 in some embodiments.

The trained ML model 314A can be configured to detect a target feature, such as one or more weeds, one or more target pests/insects, and/or one or more target fungi, within the image(s), that is separate from a desired growth (e.g., a crop). Additionally or alternatively, the trained ML model 314A can be configured to detect one or more target agricultural crops. One treatment storage compartment 350 may be selected from multiple treatment storage compartments according to the outcome of trained ML model 314A, for administration of a treatment by one or more treatment application element(s) 318, as described herein.

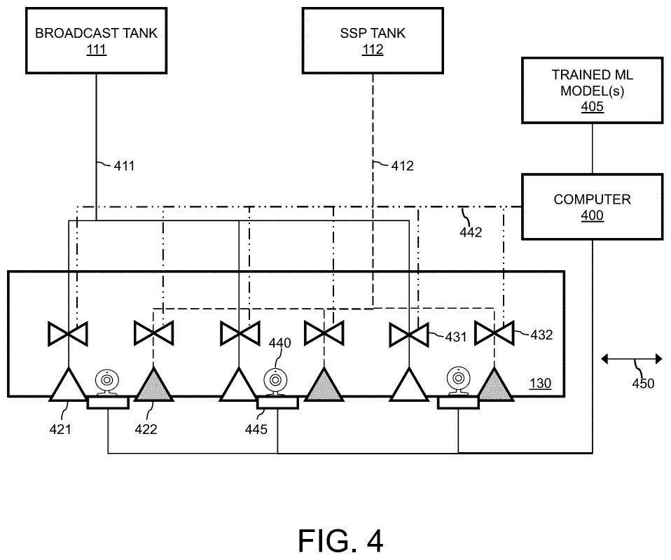

For example, an SSP tank (e.g., SSP tank 112) can be selected to provide treatment in response to the detection of a target weed (and/or another target feature). In some embodiments, only the valve(s) 432 (FIG. 4) associated with the camera 440 (FIG. 4) (or other image sensor(s) 312) and with SSP nozzle(s) 422 at the position(s) of the detected weed (and/or another target feature) in the image(s) is/are activated to precisely target the detected weed. In addition, the duty cycle of one or more valves 431 (FIG. 4) associated with the camera 440 (FIG. 4) (or other image sensor(s) 312) and with broadcast nozzles 421 at or near the position(s) of the detected weed (and/or another target feature) in the image(s) is/are increased to increase the application rate (e.g., GPA) of the general-application liquid agricultural product(s) to regions of the agricultural field at or near the position(s) of the detected weed (and/or another target feature). The general-application liquid agricultural product(s) can function as a preventative for future weed growth and/or as a general herbicide/fungicide/insecticide. The general-application liquid agricultural product(s) can include residual herbicides that persist in the soil for an extended period, controlling weeds that germinate after application. The broadcast nozzles 421 can be controlled individually and/or in groups.

Hardware processor(s) 302 of computing device 304 may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Processor(s) 302 may include a single processor, or multiple processors (homogenous or heterogeneous) arranged for parallel processing, as clusters and/or as one or more multi core processing devices.

Storage device (e.g., memory) 306 stores code instructions executable by hardware processor(s) 302, for example, a random-access memory (RAM), read-only memory (ROM), and/or a storage device, for example, non-volatile memory, magnetic media, semiconductor memory devices, hard drive, removable storage, and optical media (e.g., DVD, CD-ROM). Memory 306 stores code 307 that implements one or more features and/or instructions to be executed by the hardware processor(s) 302. Memory 306 can comprise or consist of solid-state memory and/or a solid-state device.

Computing device 304 may include a data repository 314 (e.g., storage device(s)) for storing data, for example, trained ML model(s) 314A which may include a detector component and/or a classifier component. The data repository 314 also stores the captured real-time images taken with the respective image sensor 312. The data repository 314 may be implemented as, for example, a computer memory, a local hard-drive, a solid-state drive, a solid-state memory, virtual storage, a removable storage unit, an optical disk, a storage device, and/or as a remote server and/or computing cloud (e.g., accessed using a network connection). Additional details regarding the trained ML model(s) 314A, the training dataset(s) 314B, and/or other components of system 30 are described in U.S. Pat. No. 11,393,049, titled “Machine Learning Models For Selecting Treatments For Treating an Agricultural Field,” which is hereby incorporated by reference.

Computing device 304 is in communication with one or more treatment storage compartment(s) (e.g., tanks) 350 and/or treatment application elements 318 (e.g., including respective valves such as valves 431, 432) that apply treatment for treating the field and/or plants growing on the field. There may be two or more treatment storage compartment(s) 350, for example, one or more compartments (e.g., SSP tank 112) storing chemical(s) specific to a target growth such as one or more weeds, and another one or more compartments (e.g., broadcast tank 111) storing broad chemical(s) that are non-specific to target growths such as designed for different types of target features such as weeds, pests/insects, fungi, and/or for the prevention of such target features. One or more of the treatment storage compartment(s) 350 can comprise a portion of a direct injection system. In an embodiment, the system 30 can include a first direct injection system for the chemical(s) specific to a target feature (e.g., one or more weeds) and/or a second direct injection system for the broad chemical(s) that are non-specific to target features.

There may be one or multiple treatment application elements 318 connected to the treatment storage compartment(s) 350, for example, one or more spot sprayers connected to a first compartment (e.g., SSP tank 112) storing specific chemicals for one or more target features (e.g., weeds, pests/insects, fungi, etc.), and one or more broadcast sprayers (e.g., broadcast nozzles 421 (FIG. 4)) connected to a second compartment (e.g., broadcast tank 111) storing non-specific chemicals for different types of weeds. A respective valve (e.g., valve 431 or valve 432 (FIG. 4)) can be opened and closed to drive fluid through each broadcast spray nozzle(s) or each SSP nozzle(s) 422 (FIG. 4). Alternatively, each spot sprayer and/or each broadcast sprayer can include a respective valve. The valves can be opened and closed at a frequency and at a variable duty cycle as described herein.

Computing device 304 and/or imaging and treatment arrangement 308 may include a network interface 320 for connecting to a network 322, for example, one or more of, a network interface card, an antenna, a wireless interface to connect to a wireless network, a physical interface for connecting to a cable for network connectivity, a virtual interface implemented in software, network communication software providing higher layers of network connectivity, and/or other implementations.

Computing device 304 and/or imaging and treatment arrangement 308 may communicate with one or more client terminals 328 (e.g., smartphones, mobile devices, laptops, smart watches, tablets, desktop computer) and/or with a server(s) 330 (e.g., web server, network node, cloud server, virtual server, virtual machine) over network 322. Client terminals 328 may be used, for example, to remotely monitor imaging and treatment arrangement(s) 308 and/or to remotely change parameters thereof. Server(s) 330 may be used, for example, to remotely collect data from multiple imaging and treatment arrangement(s) 308 optionally of different agricultural machines, for example, to create new training datasets and/or update exiting training datasets for updating the trained ML model(s) 314A with new images.

Network 322 may be implemented as, for example, the internet, a local area network, a wire-area network, a virtual network, a wireless network, a cellular network, a local bus, a point-to-point link (e.g., wired), and/or combinations of the aforementioned.

Computing device 304 and/or imaging and treatment arrangement 308 includes and/or is in communication with one or more physical user interfaces 326 that include a mechanism for user interaction, for example, to enter data (e.g., define threshold and/or set of rules) and/or to view data (e.g., results of which treatment was applied to which portion of the field).

Example physical user interfaces 326 include, for example, a touchscreen, a display, gesture activation devices, a keyboard, a mouse, and/or voice-activated software using speakers and a microphone. Alternatively, client terminal 328 serves as the user interface by communicating with computing device 304 and/or server 330 over network 322.

Treatment application elements 318 may be adapted for spot spraying and/or broad (e.g., band) spraying, for example as described in U.S. Provisional Patent Application No. 63/149,378, filed on Feb. 15, 2021, and/or in U.S. Pat. No. 11,393,049, which are hereby incorporated by reference.

System 30 may include a hardware component 316 associated with the agricultural machine 310 for dynamic adaption of the liquid agricultural products applied by the treatment application element(s) 318 according to dynamic orientation parameter(s) computed by analyzing an overlap region of images captured by image sensors 312, for example as described in U.S. Provisional Patent Application No. 63/082,500, filed on Sep. 24, 2020, and/or in U.S. Pat. No. 11,393,049, which are hereby incorporated by reference.

FIG. 4 is a simplified block diagram of fluid and electrical circuits for a sprayer system 10, 20, 30 according to one or more embodiments. One or more fluid lines 411 fluidly couple the broadcast tank 111 to a plurality of broadcast nozzles 421 on the spray boom 130. One or more fluid lines 412 fluidly couple the SSP tank 112 to a plurality of SSP nozzles 422 on the spray boom 130. The spray boom 130 extends along and/or parallel to a horizontal axis 450. Electromechanically actuated valves 431 (e.g., broadcast valves) are located on and/or fluidly coupled to the fluid line(s) 411 between each broadcast nozzle 421 and the broadcast tank 111. Electromechanically actuated valves 432 (e.g., SSP valves) are located on and/or fluidly coupled to the fluid line(s) 412 between each SSP nozzle 422 and the SSP tank 112.

Each valve 431, 432 can include a solenoid that allows the respective valve 431, 432 to open and close in response to control signals from the computer 400, which can be sent wirelessly and/or over electrical communication lines 442. In some embodiments, there may be only one SSP nozzle 422 and/or only one broadcast nozzle 421. In some embodiments, the SSP nozzle(s) 422 can include the respective valve(s) 432 and/or the broadcast nozzle(s) 421 can include the respective valve(s) 431.

Lights 445 such as light-emitting diodes (LEDs) can be used provide light (e.g., flash) for the agricultural field. The cameras 440 and lights 445 are in electrical communication with the computer/controller 400 to coordinate timing and/or frequency of the cameras 440 and lights 445. The computer/controller 400 can receive images from the cameras 400 and can feed the images through one or more trained machine learning models 405 to detect target features (e.g., weeds) in the images. The trained model(s) 405 can be trained using first images that include the target features and second images that do not include the target features. The trained model(s) 405 can be the same as trained ML model(s) 314A. The field of view of each camera 440 and/or other image sensor(s) is aligned with and corresponds to the position of one or more SSP nozzles 422 and to the position of one or more broadcast nozzles 421.

The fluid circuits for the broadcast tank 111 and the SSP tank 112 can include additional components, such as pumps, filters, sensors, and/or other components.

The state of each valve 431, 432 is controlled by a computer or controller 400 which is electrically coupled to each valve 431, 432. The computer/controller 400 can be the same as computing device 304. Additional computers and/or controllers can be provided. In some embodiments, only some of the valves 431 are controlled by the computer 400.

The broadcast valves 431 can always or continuously be in an active state to apply the general-application liquid agricultural product(s) broadly to the agricultural field. In the active state, the broadcast valves 431 can be repeatedly opened and closed at a frequency and at a variable duty cycle. The duty cycle represents the percentage of each frequency cycle in which a broadcast valve 431 is opened. For example, a duty cycle of 80% indicates that the broadcast valve 431 is opened for 80% of each frequency cycle and closed for 20% of each frequency cycle. Thus, the duty cycle corresponds to the application rate (e.g., GPA) of general-application liquid agricultural product(s) applied by a given broadcast valve 431.

When the trained ML model(s) 405 detect one or more target features in the images obtained by the cameras 440, the computer 400 can cause (e.g., via control signals) the duty cycle of the broadcast valves 431 for one or more broadcast nozzles 421 to increase relative to a default duty cycle. The duty cycle can be increased for the broadcast valve(s) 431 that is/are coupled to the broadcast nozzle(s) 421 that is/are aligned with regions of the agricultural field where the target feature(s) is/are detected and/or with neighboring regions of the agricultural field. The computer 400 can maintain the duty cycle (e.g., at a lower default duty cycle) for the other broadcast valves 431.

The increase in duty cycle of the broadcast valve(s) 421 causes the application rate of the general-application liquid agricultural product(s) to increase for those broadcast nozzle(s) 431. The increased application rate of general-application liquid agricultural product(s) is limited to regions at or near where target feature(s) have already been detected, for example to apply additional general herbicides, such as additional residual herbicides or a mixture of residual and non-residual herbicides, to regions at or near where one or more target weeds have been detected. The duty cycle of the other broadcast valves 431 and the respective application rate of the general-application liquid agricultural product(s) from the other broadcast nozzles 421 are maintained at the lower default duty cycle and default application rate, respectively.

In some embodiments, the default duty cycle (and corresponding default application rate) of the broadcast valves 431 can vary with the speed of the agricultural vehicle. For example, the default duty cycle can increase when the speed of the agricultural vehicle increases or reaches an upper threshold, and the default duty cycle can decrease when the speed of the agricultural vehicle decreases or reaches a lower threshold. The variable default duty cycle of the broadcast valves 431 can cause the application rate of the general-application liquid agricultural product(s) to remain the same or about the same (e.g., within about 10%) regardless of the speed of the spray boom 130 and agricultural vehicle.

The increase in the duty cycle of the broadcast valve(s) 431 in response to the detection of target feature(s) in images can be relative to the default duty cycle. For example, the increase in the duty cycle in response to the detection of target feature(s) can be a fixed increase (e.g., an increase of 0.2 such as from a default duty cycle of 0.5 to an increased duty cycle of 0.7) or a relative increase (e.g., an increase of 20% from the default duty cycle, such as increasing from a default duty cycle of 0.5 to an increased duty cycle of 0.6).

When the trained ML model(s) 405 detect one or more target features in the images obtained by the cameras 440, the computer 400 produces control signals that selectively activates one or more SSP valves 432 to apply specific liquid agricultural product(s) to one or more regions of the agricultural field where the target feature(s) is/are detected. The SSP valve(s) 432 selected to be activated can be determined based on which camera 400 acquired the image and/or the location of the detected target feature(s) within the image.

When the SSP valve(s) 432 is/are in the activated state, the SSP valve(s) 432 can be repeatedly open and closed at a frequency and at a variable duty cycle. The frequency of the SSP valve(s) 432 can be the same as or different than the frequency of the broadcast valve(s) 431. In addition, the duty cycle of the SSP valve(s) 432 can be the same as or different than the duty cycle of the broadcast valve(s) 431.

The frequency and/or duty cycle of the SSP valve(s) 432 and/or of the broadcast valve(s) 431 can vary with the speed of the agricultural vehicle. For example, the duty cycle of the SSP valve(s) 432 and/or the broadcast valve(s) 431 can increase when the speed of the agricultural vehicle increases or reaches an upper threshold, and the duty cycle can decrease when the speed of the agricultural vehicle decreases or reaches a lower threshold. The variable duty cycle of the SSP valve(s) 432 can cause the application rate of the specific liquid agricultural product(s) to remain the same or about the same (e.g., within about 10%) regardless of the speed of the agricultural vehicle. The duty cycle of the broadcast valve(s) 431 can vary between a default duty cycle and an increased duty cycle, in response to the detection of target feature(s), as discussed above.

In some embodiments, the SSP tank 112, the SSP valve(s) 432, and the fluid line(s) 412 can be optional.

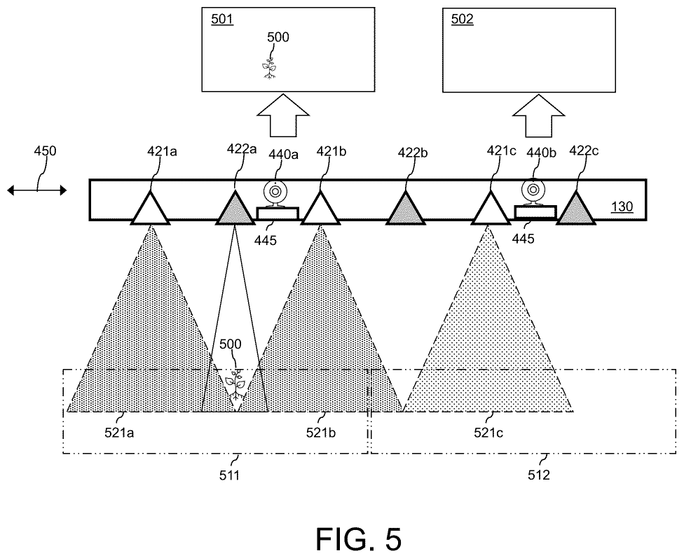

FIG. 5 is a simplified block diagram of a spray boom 130 to illustrate the variable application rate of the general-application liquid agricultural product(s) according to one or more embodiments. A first camera 440a on the spray boom 130 captures an image 501 of a first region 511 of an agricultural field that includes a target weed 500. A second camera 440b on the spray boom 130 captures an image 502 of a second region 512 of the agricultural field that does not include a target weed.

The first and second images 501, 502 are provided as inputs to one or more trained ML models 405 (FIG. 4), 314A (FIG. 3) where the target weed 500 is detected in image 501 but no target weeds are detected in image 502. In response to the detection of the target weed 500 in image 501, the computer 400 (FIG. 4) (a) increases the duty cycle of broadcast nozzles 421a, 421b (e.g., of the respective broadcast valves 431 (FIG. 4)) relative to a default duty cycle and (b) selectively sprays the target weed 500 using optional SSP nozzle 422a. In response to not detecting a target weed in image 502, the computer 400 (FIG. 4) (a) maintains the duty cycle of broadcast nozzle 421c at the lower default duty cycle and (b) does not selectively spray using optional SSP nozzle 422b, 422c (e.g., assuming the spray areas of the SSP nozzles 422b and 422c are within the field of view of the second camera 440b). The increased duty cycle of the broadcast nozzles 421a, 421b increases the application rate of general-application liquid agricultural product(s) to respective regions 521a, 521b (e.g., to the first region 511) of the agricultural field compared to the application rate to region 521c (e.g., to the second region 512) from broadcast nozzle 421c that has the lower default duty cycle.

In some embodiments, only the duty cycle of broadcast nozzle 421a or the duty cycle of broadcast nozzle 421b is increased. In some embodiments, the duty cycle of broadcast nozzle 421a, 421b, and/or 421c can be increased when one or more of their respective spray areas (e.g., regions 521a-c) has a high weed count according to historical weed data.

In some embodiments, the computer 400 can increase the duty cycle of broadcast nozzle 421c, in addition to the duty cycle of broadcast nozzle 421a or 421b, to increase the application rate of general-application liquid agricultural product(s) to a region 521c of the agricultural field that is neighboring or adjacent to a region (e.g., region 521b and/or region 511) where a target weed 500 is detected. Region 521c is a lateral neighboring region of region 521b, for example parallel to the horizontal axis 450.

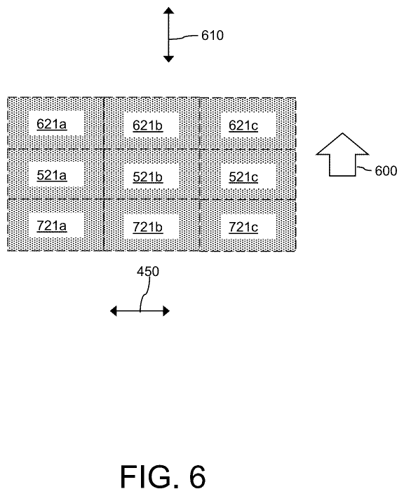

In some embodiments, the broadcast nozzles 421a, 421b, and/or 421c can apply the general-application liquid agricultural product(s) at an increased duty cycle for a predetermined time period or a predetermined distance before and/or after applying the general-application liquid agricultural product(s) to regions 521a, 521b, and/or 521c so as to apply the general-application liquid agricultural product(s) at the increased duty cycle to respective regions 621a, 621b, and/or 621c and/or to respective regions 721a, 721b, and/or 721c, in addition to regions 521a, 521b, and/or 521c. Regions 621a, 621b, and 621c are neighboring or adjacent to regions 521a, 521b, and 521c, respectively, with respect to an axis 610 that extends parallel to the direction of travel 600 of the spray boom 130 and/or with respect to axis 450, as illustrated in FIG. 6. Regions 721a, 721b, and 721c are neighboring or adjacent to regions 521a, 521b, and 521c, respectively, with respect to axis 610 and/or with respect to axis 450. Axes 450 and 610 are mutually orthogonal.

In some embodiments, the broadcast nozzles 421a and 421c are always in the activated state to apply the general-application liquid agricultural product at a predetermined (e.g., default) rate. Broadcast nozzle 421b can be selectively opened and closed to increase the application rate of the general-application liquid agricultural product. For example, when a target weed 500 is detected, broadcast nozzle 421b can be selectively opened to increase the application rate of the general-application liquid agricultural product to region 521b, which can at least partially overlap region 521a.

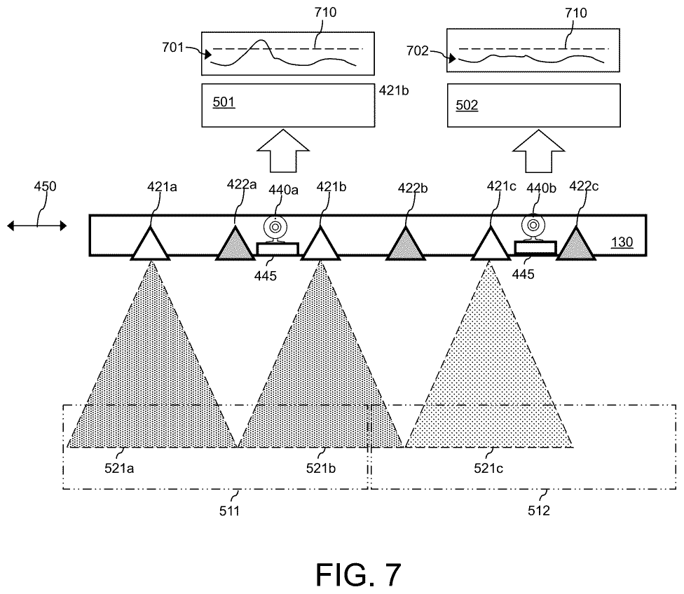

FIG. 7 is a simplified block diagram of a spray boom 130 to illustrate the variable application rate of the general-application liquid agricultural product(s) according to another embodiment. FIG. 7 is the same as FIG. 5 except that in FIG. 7 no target weeds are detected in the first and second images 501, 502. However, historical weed data 701, 702 for the first and second regions 511, 512, respectively, of the agricultural field indicate that the first region 511 has high historical weed data 701 (e.g., above a threshold 710) and that the second region 512 has low historical weed data 702 (e.g., less than or equal to the threshold 710).

In response to the high historical weed data 701 and not detecting a target weed in image 501, the computer 400 (FIG. 4) (a) increases the duty cycle of broadcast nozzles 421a, 421b (e.g., of the respective broadcast valves 431 (FIG. 4)) relative to a default duty cycle and (b) does not selectively spray the target weed 500 using optional SSP nozzle 422a. In response to the low historical weed data 702 and not detecting a target weed in image 502, the computer 400 (FIG. 4) (a) maintains the duty cycle of broadcast nozzle 421c at the lower default duty cycle and (b) does not selectively spray using optional SSP nozzle 422b, 422c (e.g., assuming the spray areas of the SSP nozzles 422b and 422c are within the field of view of the second camera 440b). The increased duty cycle of the broadcast nozzles 421a, 421b increases the application rate of general-application liquid agricultural product(s) to respective regions 521a, 521b (e.g., to the first region 511) of the agricultural field compared to the application rate to region 521c (e.g., to the second region 512) from broadcast nozzle 421c that has the lower default duty cycle.

In some embodiments, the computer 400 can increase the duty cycle of broadcast nozzle 421c, in addition to the duty cycle of broadcast nozzle 421a or 421b, to increase the application rate of general-application liquid agricultural product(s) to a region 521c and/or to the second region 512 of the agricultural field that is neighboring or adjacent to a region (e.g., first region 511) having high historical weed data 701. Region 521c, 512 is a lateral neighboring region of region 511, for example parallel to the horizontal axis 450.

In some embodiments, the broadcast nozzles 421a, 421b, and/or 421c can apply the general-application liquid agricultural product(s) at an increased duty cycle for a predetermined time period or a predetermined distance before and/or after applying the general-application liquid agricultural product(s) to regions 521a, 521b, and/or 521c so as to apply the general-application liquid agricultural product(s) at the increased duty cycle to respective neighboring regions 621a, 621b, and/or 621c and/or to respective neighboring regions 721a, 721b, and/or 721c, in addition to regions 521a, 521b, and/or 521c (e.g., as illustrated in FIG. 6).

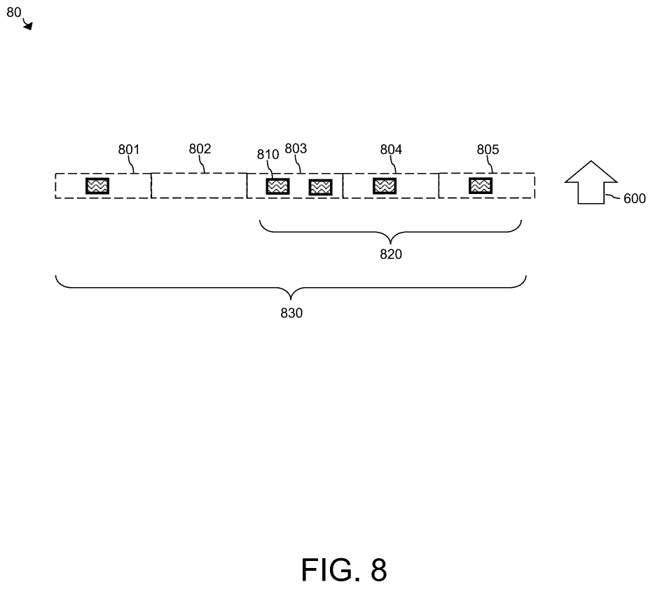

FIG. 8 illustrates examples images 801-805 of an agricultural field 80 according to one or more embodiments. Weeds 810 are detected in images 801 and 803-805 and are not detected in image 802. In an embodiment, only the broadcast nozzles 421 (FIG. 4) associated with images 801, 803-805 apply the general-application liquid agricultural product(s) at an increased duty cycle at those respective regions while the other broadcast nozzle(s) 421 associated with image 802 applies the general-application liquid agricultural product(s) at that region at the default duty cycle. The computer 400 (FIG. 4) can determine that images 803-805 represent a cluster 820 of weeds, which can cause the broadcast nozzles 421 for neighboring regions to spray at the increased duty cycle. For example, the computer 400 can cause the broadcast nozzles 421 associated with image 802 to spray at an increased duty cycle even though weeds are not detected in image 802. Additionally or alternatively, the computer 400 can cause the broadcast nozzles 421 to spray regions before and/or after the regions associated with images 801, 803-805 and optionally with image 802 at an increase duty cycle.

In some embodiments, the computer can determine that images 801-805 represent a cluster 830 for example when the distance between a weed 810 detected in image 801 is less than or equal to a threshold distance from a weed 810 detected in image 803. The threshold distance can be fixed or can vary based on the number of weeds detected in cluster 820. For example, when a relatively high number of weeds is detected in cluster 820, the threshold distance can be small while when a relatively low number of weeds is detected in cluster 820, the threshold distance can be high. All broadcast nozzles 421 associated with cluster 830 can spray at an increased duty cycle compared to a default duty cycle.

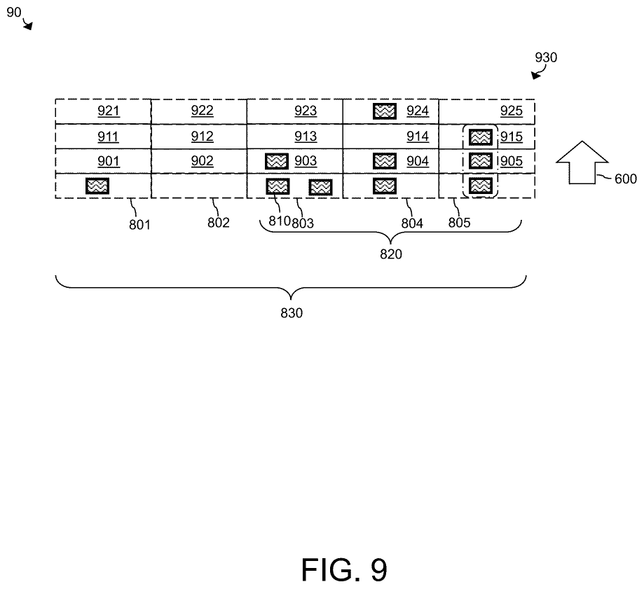

FIG. 9 illustrates examples images 801-805, 901-905, 911-915, 921-925 of an agricultural field according to another embodiment. Weeds are detected in images 801, 803-805, 903-905, 915, and 924. Weeds are not detected in images 802, 901, 902, 911-914, 921-923, and 925. The computer 400 (FIG. 4) can determine that images 805, 905, and 915 represent a cluster 930. Additionally or alternatively, the computer 400 can determine that images 804 and 904 represent a cluster 930 or that images 804, 905, 914, and 924 represent a cluster 930. Additionally or alternatively, the computer 400 can determine that images 803 and 903 represent a cluster 930. Additionally or alternatively, the computer 400 can determine that images 803-805, 903-905 and 915 represent a cluster 930 or that images 803-805, 903-905, 915, 924, and optionally images 913, 914, 923, and/or 925 represent a cluster 930. The size of a cluster 930 can vary based on the number of weeds detected (e.g., a larger size cluster 930 when a large number of weeds 810 is detected or a smaller size cluster 930 when a small number of weeds 810 is detected).

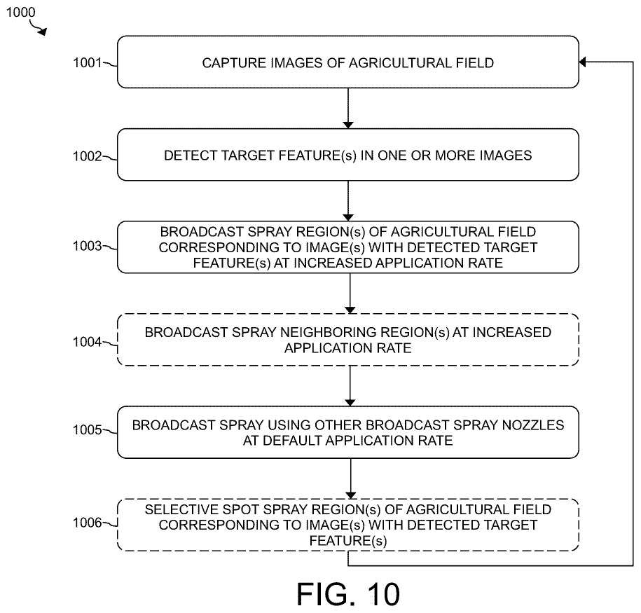

FIG. 10 is a flow chart of a method 1000 for broadcast spraying an agricultural field using a variable duty cycle according to one or more embodiments.

In step 1001, images of respective regions of an agricultural field are captured using one or more cameras 440 (or other image sensors) mounted on a spray boom 130. The respective regions are located in front of the spray boom 130 (e.g., along its direction of travel) and are located laterally from each other (e.g., along or parallel to a horizontal axis 450). The spray boom 130 can be pushed or pulled by an agricultural vehicle.

In step 1002, target feature(s) is/are detected in one or more of the images. The target feature(s) can be detected using one or more trained ML models 314A, 405. In some embodiments, the target feature(s) can include or can be an undesired growth such as one or more weeds (e.g., weed 500, 810).

In step 1003, one or more regions of the agricultural field is/are broadcast sprayed at an increased application rate (compared to a default application rate) using one or more broadcast spray nozzle(s) 421. The region(s) that is/are broadcast sprayed with an increased application rate (e.g., GPA) corresponds to the image(s) in which target feature(s) is/are detected. The broadcast spray nozzle(s) 421 can spray the regions(s) using a higher duty cycle, compared to a lower default duty cycle, to achieve the increased application rate. The increased duty cycle increases the application rate (e.g., GPA) of the general-application liquid agricultural product(s) to the region(s) where target feature(s) is/are detected, for example to apply additional residual herbicide to those region(s). Additionally or alternatively, one or more broadcast spray nozzle(s) 421 can transitioned from an off state to an on state to apply additional general-application liquid agricultural product(s) to the region(s) while other broadcast spray nozzles spray at a constant rate.

In some embodiments, a cluster of the target feature(s) is determined in which case all regions corresponding to the cluster are sprayed at an increased application rate (e.g., increased duty cycle).

In optional step 1004, one or more neighboring regions of the agricultural field is/are broadcast sprayed at an increased application rate (compared to a default application rate) using one or more broadcast spray nozzle(s) 421. The neighboring region(s) is/are neighboring or adjacent to the region(s) where target feature(s) is/are detected and/or to a cluster of the target feature(s). The neighboring region(s) can be laterally adjacent to the region(s) where target feature(s) is/are detected and/or to a cluster of the target feature(s), for example along axis 450 (FIGS. 4-6). Additionally or alternatively, the neighboring region(s) can be adjacent to the region(s) where target feature(s) is/are detected and/or to a cluster of the target feature(s) along the direction of travel 600 of the spray boom, for example along axis 610 (FIGS. 6, 8, 9). The broadcast nozzle(s) 421 can broadcast spray the neighboring regions(s) using a higher duty cycle, compared to a lower default duty cycle, to achieve the increased application rate.

In step 1005, the broadcast nozzles 421 that do not apply the general-application liquid agricultural product(s) at an increased application rate (e.g., at a higher duty cycle) in step 1003 and/or in optional step 1004 apply the general-application liquid agricultural product(s) at a lower default application rate (e.g., at a lower/default default duty cycle), which is lower than the increased application rate in step 1003 and in optional step 1004. In other words, each broadcast nozzles 421 can apply the general-application liquid agricultural product(s) at the lower default application rate unless its application rate is temporarily increased in step 1003 or in optional step 1004. In this way, the general-application liquid agricultural product(s) is/are applied at a lower rate to regions of the agricultural field where target feature(s) is/are not detected and/or to regions of the agricultural field that are far away from (e.g., not neighboring) the regions of the agricultural field where target feature(s) is/are detected.

In optional step 1006, the region(s) corresponding to the image(s) in which target feature(s) is/are detected is/are selective spot sprayed with specific liquid agricultural product(s) using SSP nozzles 422.

Steps 1001-1006 can be repeated as the spray boom 130 is moved along the agricultural field.

In some embodiments, one or more additional factors can be used to determine whether to increase the application rate of the general-application liquid agricultural product(s). Such factor(s) can include the historical target feature data of each region of the agricultural field (e.g., historical weed data), historical weather data, weather forecasts, and/or other factors. For example, the application rate of the general-application liquid agricultural product(s) can be increased in regions where the historical target feature data indicate that a high number or concentration of weeds (e.g., greater than a predetermined number per area) was present in one or more prior years.

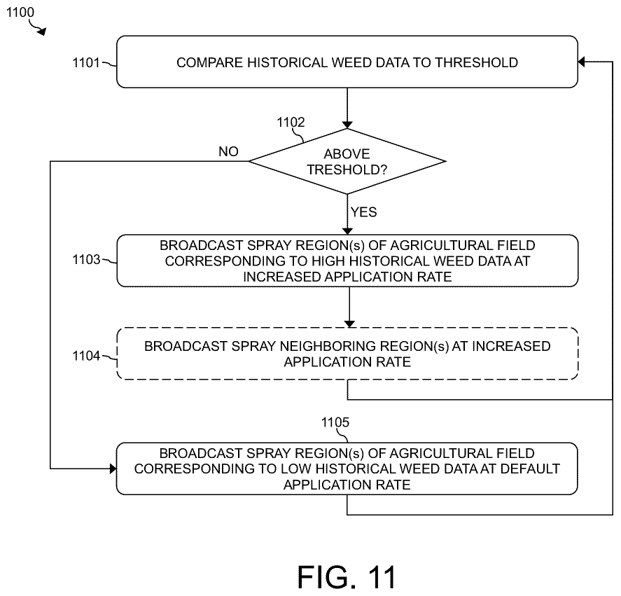

FIG. 11 is a flow chart of a method 1100 for broadcast spraying an agricultural field using a variable duty cycle according to another embodiment.

In step 1101, a computer 400 (FIG. 4) compares historical weed data for regions of an agricultural field to a predetermined threshold. The historical weed data can be stored in memory accessible to the computer to another computer in communication therewith.

When the historical weed data is higher than the threshold (step 1102=yes), in step 1103 the respective region(s) is/are broadcast sprayed at an increased application rate (compared to a default application rate) using one or more broadcast spray nozzle(s) 421. The region(s) that is/are broadcast sprayed with an increased application rate (e.g., GPA) corresponds to the image(s) in which target feature(s) is/are detected. The broadcast spray nozzle(s) 421 can spray the regions(s) using a higher duty cycle, compared to a lower default duty cycle, to achieve the increased application rate. Additionally or alternatively, one or more broadcast spray nozzle(s) 421 can transitioned from an off state to an on state to apply additional general-application liquid agricultural product(s) to the region(s) while other broadcast spray nozzles spray at a constant rate.

In optional step 1104, one or more neighboring regions of the agricultural field is/are broadcast sprayed at an increased application rate (compared to a default application rate) using one or more broadcast spray nozzle(s) 421. The neighboring region(s) is/are neighboring or adjacent to the region(s) having high historical weed data. The neighboring region(s) can be laterally adjacent to the region(s) having high historical weed data. Additionally or alternatively, the neighboring region(s) can be adjacent to the region(s) having high historical weed data along the direction of travel 600 of the spray boom, for example along axis 610 (FIGS. 6, 8, 9). The broadcast nozzle(s) 421 can broadcast spray the neighboring regions(s) using a higher duty cycle, compared to a lower default duty cycle, to achieve the increased application rate.

When the historical weed data is lower than or equal to the threshold (step 1102=no) and the respective regions are not neighboring regions that are sprayed at an increased application rate in optional step 1104, the respective region(s) is/are broadcast sprayed at a lower default application rate using one or more broadcast spray nozzle(s) 421 in step 1105.

Methods 1000, 1100 can be combined such that the broadcast spray nozzle(s) 421 spray at an increased application rate when either (a) target feature(s), such as weeds, is/are detected in the respective region(s) and/or (b) historical weed data for the respective region(s) are higher than a threshold.

After step 1103 (or optional step 1104) and/or step 1105, the method 1100 can return to step 1101. Alternatively, step 1101 can only be performed once and the respective data can be stored in memory operably coupled to the computer.

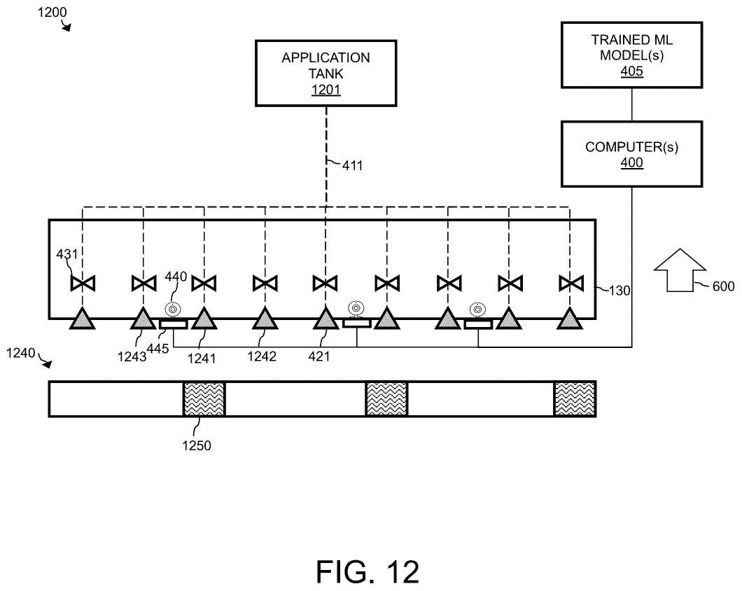

FIG. 12 is a simplified block diagram of fluid and electrical circuits 1200 for a sprayer system 10, 20, 30 according to another embodiment. One or more fluid lines 411 fluidly couple an application tank 1201 to the broadcast nozzles 421 on the spray boom 130. Electromechanically actuated valves 431 are located on and/or are fluidly coupled to the fluid line(s) 411 between each broadcast nozzle 421 and the application tank 1201 such that each broadcast nozzle 421 can be individually activated. The application tank 1201 can store an herbicide mixture of residual herbicide(s) and non-residual herbicide(s).

The broadcast nozzles 421 can apply a default application rate of the herbicide mixture using a default duty cycle (and a frequency) of valves 431. When target features 1250, such as target weeds, are detected in one or more acquired images, the computer 400 can increase the duty cycle of the corresponding/respective valves 421 to spray the target features 1250 at an increased application rate, compared to the default application rate, with the respective broadcast nozzles 431. The spray area can vary in size based on the number of detected target plants in a given image or in a given sequence of images (e.g., taken by different cameras 330 across the spray boom 230 simultaneously and/or taken by the same camera 330 at different times as the agricultural vehicle travels along the agricultural field 1240). Additionally or alternatively, the spray area can vary in size based on historical data of locations where target plants have grown in the agricultural field 340. The spray area can represent a higher-probability area/location where target plants such as weeds are present or may be present in the future.

When only a given broadcast nozzle 421, such as broadcast nozzle 1241, is needed to spray a detected target feature 1250 at an increased application rate, one or more additional spray nozzles, such as broadcast nozzle(s) 1242 and/or 1243, on either lateral side of broadcast nozzle 1241 can be activated to increase the “width” of the spray area (i.e., to the left and/or right of the detected target feature 1250 in FIG. 12) having an increased application rate. In addition, the broadcast nozzle 1241 and any additional broadcast nozzle(s) 421 can be activated for a longer period to increase the “length” of the spray area having an increased application rate along the direction of travel 600 of the agricultural vehicle (i.e., vertically up and down of the detected target feature 1250 in FIG. 12). For example, the duty cycle of the relevant broadcast nozzles 421 can be increased early to spray a portion of the agricultural field before (in front of) the detected target feature 1250 with an increased application rate in addition to the detected target plant 350 itself. In another example, the relevant broadcast nozzles 421 can be remain at an increased duty cycle after spraying the detected target feature 1250 to spray a portion of the agricultural field after (behind) the detected target feature 1250 in addition to the detected target plant 350 itself. A combination is also possible where the duty cycle of the relevant broadcast nozzles 421 is increased before and after the detected target feature 1250.

The trained machine learning model(s) 405 determine the spray area for each target plant or target-plant group detected. Factors for determining the spray area can include the number of target plants detected within a given area, the growth stage of the target plants, the type(s) of target plants detected, and/or historical target-plant data for the agricultural field including historical target-plant data for the specific location of the agricultural vehicle on the agricultural field. Determining the number of target plants in a group can be based on the species, genus, family, and/or order of the detected target plants. Additionally or alternatively, the number of target plants in a group can be based on combining the number of target plants in a group, such as combining weeds that are broadleaves and/or grasses. Additionally or alternatively, the number of target plants in a group can be based on combining all detected weeds regardless of the type(s) of target plant.

In some embodiments, a broadcast nozzle 421 is only activated when a detected target feature 1250 is detected to locally increase the application rate of the herbicide mixture at the detected target feature 1250 and optionally neighboring region(s), similar to a selective spot spray nozzle.

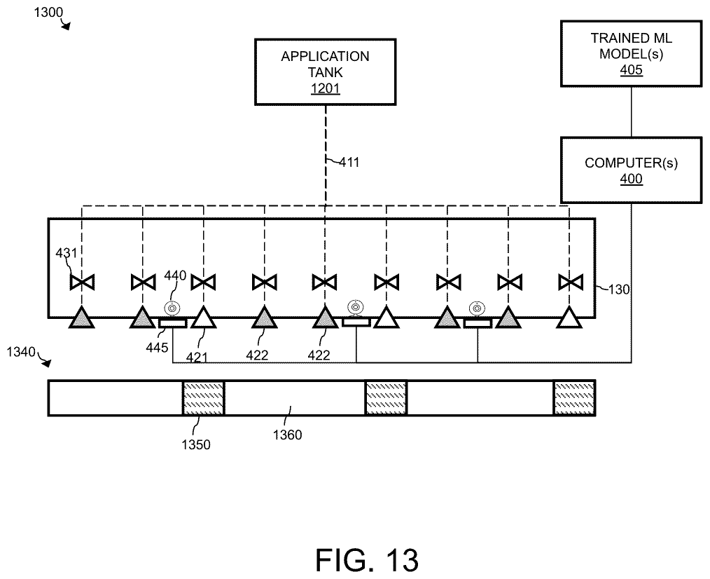

FIG. 13 is a simplified block diagram of fluid and electrical circuits 1300 for a sprayer system 10, 20, 30 according to another embodiment. The fluid and electrical circuits 1300 are the same as the fluid and electrical circuits 1200 except that in the fluid and electrical circuits 1300, some of the spray nozzles operate as broadcast nozzles 421 and some of the spray nozzles operate as SSP nozzles 422. The broadcast nozzles 421 are aligned with crop rows 1350 in an agricultural field 1340 and spray a continuous or substantially continuous spray to the crop rows 1350. The valves 320 are maintained in the activated state at a variable default duty cycle for the broadcast nozzles 421.

The SSP nozzles 442 are aligned with the spaces 1360 between crops rows 1350 and are operated, as discussed above, in response to the detection of target features (e.g., target plants such as target weeds) using one or more trained machine learning models 405. As such, the computer/controller 400 sends control signals to the valves 431 for the SSP nozzles 422 to selectively open and close the respective valves 431 to apply the herbicide mixture when target features, such as target weeds, are detected in the acquired images.

The crop rows 1350 are typically about 10 inches wide and the space between neighboring crop rows 1350 is typically about 20 inches wide. For example, the most common row spacing is off-center 30 inches in corn and soybeans. The spray nozzles on the spray boom 130 can have a 10 inch off-center nozzle spacing such that every third spray nozzle is a broadcast nozzle 441 and the two spray nozzles between neighboring broadcast nozzles 441 are selective SSP nozzles 442. In one example, starting with the second nozzle, every third spray nozzle (e.g., 2, 5, 8, 11 . . . ) is a broadcast nozzle 441 to apply a continuous spray on the canopy. The other spray nozzles are SSP nozzles 442.

This embodiment/configuration may be useful for strip-till farmers that may till the rows about a month after spraying.

The spray rate/volume of the herbicide mixture applied through the broadcast nozzles 421 can be different than the spray rate/volume of the herbicide mixture applied through the SSP nozzles 422, such that a variable rate/volume of herbicide mixture can be applied. For example, a relatively low rate/volume of herbicide mixture can be applied through the broadcast nozzles 421 and a relatively high rate/volume of herbicide mixture can be applied through the SSP nozzles 422. The spray rate/volume can be controlled by adjusting the duty cycle of the respective valves 431, as discussed above.

In another embodiment, a first group of spray nozzles can operate as broadcast nozzles 421 and a second group of spray nozzles can operate as SSP nozzles 422 to apply a variable rate/volume of herbicide mixture, as discussed above.

In another embodiment, a second application tank can be fluidly coupled to the spray nozzles and/or to other spray nozzles. The second application tank can hold the same herbicide mixture, another herbicide, and/or another substance such as fertilizer.

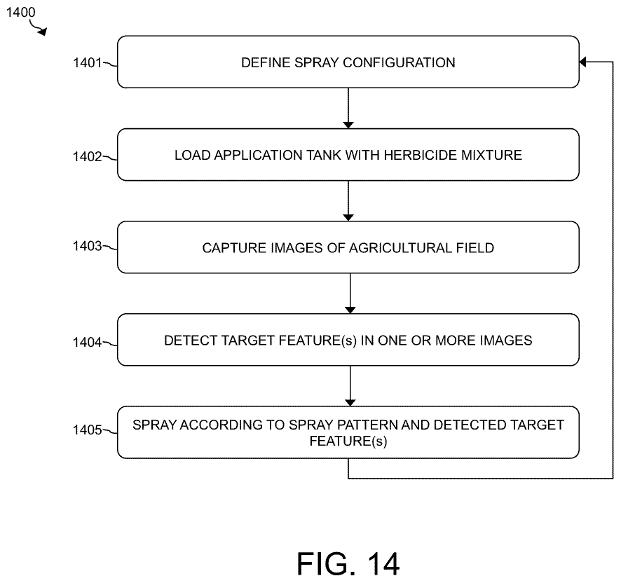

FIG. 14 is a flow chart for a method 1400 for applying residual and non-residual herbicides to target plants or features according to one or more embodiments.

In step 1401, rules are defined in a computer. The rules determine a spray area and/or a spray configuration for the spray nozzles including which spray nozzles function as broadcast nozzles 421 and which (if any) spray nozzles function as SSP nozzles 422. The spray area can include the size of the spray area (e.g., the length and/or width of the spray area).

In step 1402, an application tank 1201 is loaded with an herbicide mixture including residual and non-residual herbicides. The application tank 1201 is mounted on an agricultural vehicle that includes a spray boom 130 and spray nozzles on the spray boom. The spray boom 130 also includes an array of (e.g., one or more) cameras 440 and optional light sources 445. The cameras 440 are configured to acquire images of an agricultural field in the direction of travel of the agricultural vehicle. The fields of view of the cameras 440 are aligned with and correspond to the spray nozzles.

In step 1403, images of respective regions of an agricultural field are captured using the cameras 440 (or other image sensors) mounted on the spray boom 130. The respective regions are located in front of the spray boom 130 (e.g., along its direction of travel) and are located laterally from each other (e.g., along or parallel to a horizontal axis 450). The spray boom 130 can be pushed or pulled by an agricultural vehicle.

In step 1404, target feature(s) is/are detected in one or more of the images. The target feature(s) can be detected using one or more trained ML models 314A, 405. In some embodiments, the target feature(s) can include or can be an undesired growth such as one or more weeds (e.g., weed 500, 810).

In step 1405, the spray nozzles spray the corresponding regions of the agricultural field according to the spray pattern and whether any target feature(s) is/are detected in the images. The regions in which target feature(s) is/are detected can be sprayed at an increased application rate using broadcast nozzles 421. Alternatively, the regions in which target feature(s) is/are detected can be selective spot sprayed using SSP nozzles 422. Neighboring regions to the regions in which target feature(s) is/are detected can also be sprayed broadcast nozzle(s) 421 and/or SSP nozzle(s) 422.

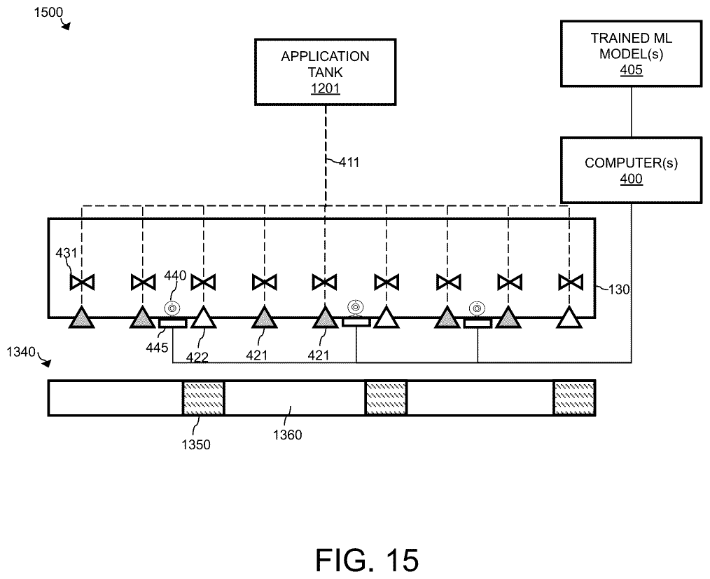

FIG. 15 is a simplified block diagram of fluid and electrical circuits 1500 for a sprayer system 10, 20, 30 according to another embodiment. The fluid and electrical circuits 1500 are the same as the fluid and electrical circuits 1300 except that in the fluid and electrical circuits 1350, the SSP nozzles 442 are aligned with the crop rows 1350 and the broadcast nozzles 441 are aligned with the spaces 1360 between the crop rows 1350.

The invention should not be considered limited to the particular embodiments described above. Various modifications, equivalent processes, as well as numerous structures to which the invention may be applicable, will be readily apparent to those skilled in the art to which the invention is directed upon review of this disclosure. The above-described embodiments may be implemented in numerous ways. One or more aspects and embodiments involving the performance of processes or methods may utilize program instructions executable by a device (e.g., a computer, a processor, or other device) to perform, or control performance of, the processes or methods.

In this respect, various inventive concepts may be embodied as a non-transitory computer readable storage medium (or multiple non-transitory computer readable storage media) (e.g., a computer memory of any suitable type including transitory or non-transitory digital storage units, circuit configurations in Field Programmable Gate Arrays or other semiconductor devices, or other tangible computer storage medium) encoded with one or more programs that, when executed on one or more computers or other processors, perform methods that implement one or more of the various embodiments described above. When implemented in software (e.g., as an app), the software code may be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a Personal Digital Assistant (PDA), a smartphone or any other suitable portable or fixed electronic device.

Also, a computer may have one or more communication devices, which may be used to interconnect the computer to one or more other devices and/or systems, such as, for example, one or more networks in any suitable form, including a local area network or a wide area network, such as an enterprise network, and intelligent network (IN) or the Internet. Such networks may be based on any suitable technology and may operate according to any suitable protocol and may include wireless networks or wired networks.

Also, a computer may have one or more input devices and/or one or more output devices. These devices can be used, among other things, to present a user interface. Examples of output devices that may be used to provide a user interface include printers or display screens for visual presentation of output and speakers or other sound generating devices for audible presentation of output. Examples of input devices that may be used for a user interface include keyboards, and pointing devices, such as mice, touch pads, and digitizing tablets. As another example, a computer may receive input information through speech recognition or in other audible formats.

The non-transitory computer readable medium or media may be transportable, such that the program or programs stored thereon may be loaded onto one or more different computers or other processors to implement various one or more of the aspects described above. In some embodiments, computer readable media may be non-transitory media.

The terms “program,” “app,” and “software” are used herein in a generic sense to refer to any type of computer code or set of computer-executable instructions that may be employed to program a computer or other processor to implement various aspects as described above. Additionally, it should be appreciated that, according to one aspect, one or more computer programs that when executed perform methods of this application need not reside on a single computer or processor but may be distributed in a modular fashion among a number of different computers or processors to implement various aspects of this application.

Computer-executable instructions may be in many forms, such as program modules, executed by one or more computers or other devices. Generally, program modules include routines, programs, objects, components, data structures, etc. that performs particular tasks or implement particular abstract data types. The functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Thus, the disclosure and claims include new and novel improvements to existing methods and technologies, which were not previously known nor implemented to achieve the useful results described above. Users of the method and system will reap tangible benefits from the functions now made possible on account of the specific modifications described herein causing the effects in the system and its outputs to its users. It is expected that significantly improved operations can be achieved upon implementation of the claimed invention, using the technical components recited herein.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

What is claimed is:

1. A method for spraying an agricultural field, comprising:
in a spray system that includes a spray boom attached to an agricultural vehicle, the spray boom including one or more cameras and a plurality of broadcast nozzles, the agricultural vehicle having an application tank that stores at least a residual herbicide:
capturing, with each camera, images of respective regions of an agricultural field, each region at a predetermined distance from the spray boom, each camera associated with one or more respective broadcast nozzles;
automatically analyzing, with a trained machine learning (ML) model running on a computer, each image for a presence of at least one target weed, the trained ML model having been trained with first images that include the at least one target weed and second images that do not include the at least one target weed;
automatically detecting, with the trained ML model, the at least one target weed in one or more of the images;
for each image in which the at least one target weed is detected, automatically spraying a respective first region with one or more respective first broadcast nozzles at an increased application rate compared to a default application rate; and
for at least some of the images in which the at least one target weed is not detected, automatically spraying a respective second region with the one or more respective second broadcast nozzles at the default application rate.

2. The method of claim 1, wherein:
automatically spraying the respective first region at the increased application rate comprises opening and closing a respective valve of each first broadcast nozzle at a frequency and an increased duty cycle compared to a default duty cycle, and
automatically spraying the respective second region at the default application rate comprises opening and closing the respective valve of each second broadcast nozzle at the frequency and the default duty cycle.

3. The method of claim 1, further comprising automatically spraying at least one neighboring region of at least one respective first region at the increased application rate.

4. The method of claim 1, further comprising:
automatically detecting, with the computer, a cluster of weeds in a group of regions of the agricultural field; and
automatically spraying the group of regions at the increased application rate.

5. The method of claim 4, further comprising automatically spraying at least one neighboring region of the group of regions at the increased application rate.

6. A method for spraying an agricultural field, comprising:
in a spray system that includes a spray boom attached to an agricultural vehicle, the spray boom including a plurality of broadcast nozzles, the agricultural vehicle having an application tank that stores at least a residual herbicide:
comparing, in a computer, historical weed data for regions of the agricultural field to a predetermined threshold;
for first regions in which the historical weed data are higher than the predetermined threshold, automatically spraying a respective first region with one or more respective first broadcast nozzles at an increased application rate compared to a default application rate; and
for at least some second regions in which the historical weed data are lower than or equal to the predetermined threshold, automatically spraying a respective second region with the one or more respective second broadcast nozzles at the default application rate.

7. The method of claim 6, wherein:
automatically spraying the respective first region at the increased application rate comprises opening and closing a respective valve of each first broadcast nozzle at a frequency and an increased duty cycle compared to a default duty cycle, and
automatically spraying the respective second region at the default application rate comprises opening and closing the respective valve of each second broadcast nozzle at the frequency and the default duty cycle.

8. The method of claim 6, further comprising automatically spraying at least one neighboring region of at least one respective first region at the increased application rate.

9. A method for spraying an agricultural field, comprising:
in a spray system that includes a spray boom attached to an agricultural vehicle, the spray boom including one or more cameras and a plurality of broadcast nozzles, the agricultural vehicle having an application tank that stores at least a residual herbicide:
comparing, in a computer, historical weed data of regions of the agricultural field to a predetermined threshold;
capturing, with each camera, a respective image of respective regions of an agricultural field, each region at a predetermined distance from the spray boom, each camera associated with one or more respective broadcast nozzles;
automatically analyzing, with a trained machine learning (ML) model running on the computer, each image for a presence of at least one target weed, the trained ML model having been trained with first images that include the at least one target weed and second images that do not include the at least one target weed;
automatically detecting, with the trained ML model, the at least one target weed in one or more of the images;
determining, with the trained ML model, a plurality of first regions of the agricultural field to spray at an increased application rate compared to a default application rate, the first regions determined using the historical weed data and/or a detection of the at least one weed in the one or more images;
automatically spraying each first region with one or more respective first broadcast nozzles at the increased application rate; and
automatically spraying one or more second regions of the agricultural field with one or more respective second broadcast nozzles at the default application rate.

10. The method of claim 9, wherein:
automatically spraying each first region at the increased application rate comprises opening and closing a respective valve of each first broadcast nozzle at a frequency and an increased duty cycle compared to a default duty cycle, and
automatically spraying the one or more second regions at the default application rate comprises opening and closing the respective valve of each second broadcast nozzle at the frequency and the default duty cycle.

11. The method of claim 9, further comprising automatically spraying at least one neighboring region of at least one first region at the increased application rate.

12. The method of claim 9, further comprising:
automatically detecting a cluster of weeds in a group of regions of the agricultural field; and
automatically spraying the group of regions at the increased application rate.

13. The method of claim 12, further comprising automatically spraying at least one neighboring region of the group of regions at the increased application rate.

14. A method for spraying an agricultural field, comprising:
in a spray system that includes a spray boom attached to an agricultural vehicle, the spray boom including one or more cameras and a plurality of spray nozzles, the agricultural vehicle having an application tank that holds an herbicide mixture that includes at least one residual herbicide and at least one non-residual herbicide, the application tank fluidly coupled to the spray nozzles:
defining, with a computer, a spray configuration for the spray nozzles;
automatically capturing, with each camera, a respective image of a respective region of an agricultural field, each region at a predetermined distance from the spray boom, each camera associated with one or more respective spray nozzles;
automatically analyzing, with a trained machine learning (ML) model running on the computer, each image for a presence of at least one target weed, the trained ML model having been trained with first images that include the at least one target weed and second images that do not include the at least one target weed;
automatically detecting, with the trained ML model, the at least one target weed in one or more of the images; and
automatically spraying respective regions of the agricultural field with the spray nozzles in the spray configuration and based, at least in part, on a detection of the at least one weed in the one or more images.

15. The method of claim 14, wherein:
the spray nozzles include broadcast nozzles, and
the method further comprises:
for each image in which the at least one weed is detected, automatically spraying a respective first region with one or more respective first broadcast nozzles at an increased application rate compared to a default application rate; and
for at least some of the images in which the at least one weed is not detected, automatically spraying a respective second region with the one or more respective second broadcast nozzles at the default application rate.

16. The method of claim 14, wherein:
the spray nozzles include broadcast nozzles and selective spot-spray (SSP) nozzles, the broadcast nozzles configured to align with respective rows of crops, the SSP nozzles configured to align with spaces between neighboring rows of crops, and
the method further comprises:
for each image in which the at least one weed is detected, automatically spraying a respective first region with one or more respective SSP nozzles; and
broadcast spraying the rows of crops with the broadcast nozzles.

17. The method of claim 14, wherein:
the spray nozzles include broadcast nozzles and selective spot-spray (SSP) nozzles, the SSP nozzles configured to align with respective rows of crops, the broadcast nozzles configured to align with spaces between neighboring rows of crops, and
the method further comprises:
for each image in which the at least one weed is detected, automatically spraying a respective first region with one or more respective SSP nozzles; and
broadcast spraying the spaces between neighboring rows of crops with the broadcast nozzles.
